(19) United States
(12) Patent Application Publication
(10) Pub. No.: US 2021/0061990 A1
(43) Pub. Date: Mar. 4, 2021

(54) FLAME-RETARDANT POLYESTER COMPOSITIONS AND THE USE THEREOF

(71) Applicant: CLARIANT PLASTICS & COATINGS LTD, Muttenz (CH)

(72) Inventors: Harald BAUER, Kerpen (DE); Sebastian HÖROLD, Diedorf (DE); Martin SICKEN, Köln (DE)

(73) Assignee: CLARIANT PLASTICS & COATINGS LTD, Muttenz (CH)

(21) Appl. No.: 16/644,591

(22) PCT Filed: Aug. 29, 2018
(86) PCT No.: PCT/EP2018/073226

§ 371 Date: Mar. 5, 2020

(30) Foreign Application Priority Data
Sep. 7, 2017 (DE) 10 2017 215 773.9

(51) Int. Cl. C08L 67/02; C08K 5/00; C08K 5/5313; C08K 5/5317; C08K 7/14; C08K 3/32; C08K 3/08; C08L 91/06; C08K 5/3492; C08G 63/183

(52) U.S. Cl. CPC C08L 67/02; C08L 2203/30; C08K 5/5313; C08K 5/5317; C08K 7/14; C08K 3/32; C08K 3/08; C08L 91/06; C08K 5/34922; C08K 5/34924; C08G 63/183; C08K 2003/327; C08K 2003/328; C08K 2201/003; C08K 2003/0856; C08L 2201/02; C08L 2203/12; C08L 2203/16; C08L 2203/20; C08K 5/0066

(57) ABSTRACT

The invention relates to flame-retardant polyester compositions comprising
thermoplastic polyester as component A,
fillers and/or reinforcers as component B,
phosphinic salt of the formula (I) as component C

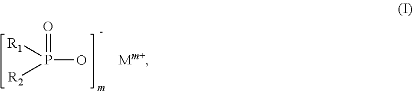

in which R₁ and R₂ are ethyl,
M is Al, Fe, TiOₚ or Zn,
m is 2 to 3, and
p=(4−m)/2
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D
phosphonic salt of the formula II as component E

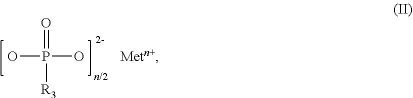

in which R₃ is ethyl,
Met is Al, Fe, TiO_{q} or Zn,
n is 2 to 3, and
q=(4−n)/2,
inorganic phosphonate as component F, and
wax selected from the group consisting of the polyolefin waxes, amide waxes, natural waxes, long-chain aliphatic carboxylic acids and/or esters or salts thereof as component G.

The polyester compositions can be used for production of fibers, films and moldings, especially for uses in the electricals and electronics sector.

The present invention relates to flame-retardant polyester compositions, and to moldings produced therefrom.

Combustible plastics generally have to be equipped with flame retardants in order to be able to attain the high flame retardancy demands made by the plastics processors and in some cases by the legislator. Preferably—for environmental reasons as well—nonhalogenated flame retardant systems that form only a low level of smoke gases, if any, are used.

Among these flame retardants, the salts of phosphinic acid (phosphinates) have been found to be particularly effective for thermoplastic polymers (DE 2 252 258 A and DE 2 447 727 A).

In addition, there are known synergistic combinations of phosphinates with particular nitrogen-containing compounds which have been found to be more effective as flame retardants in a whole series of polymers than the phosphinates alone (WO-2002/28953 A1, and also DE 197 34 437 A1 and DE 197 37 727 A1).

U.S. Pat. No. 7,420,007 B2 discloses that dialkylphosphinates containing a small amount of selected telomers as flame retardant are suitable for polymers, the polymer being subject only to quite a minor degree of degradation on incorporation of the flame retardant into the polymer matrix.

Flame retardants frequently have to be added in high dosages in order to ensure sufficient flame retardancy of the plastic according to international standards. Due to their chemical reactivity, which is required for flame retardancy at high temperatures, flame retardants, particularly at higher dosages, can impair the processing stability of plastics. This may result in increased polymer degradation, crosslinking reactions, outgassing or discoloration.

DE 10 2007 041 594 A1 discloses flame-retardant polyester compounds comprising thermoplastic polyester, polycarbonate, phosphinic salt and optionally reaction products of melamine with phosphoric acid and/or condensed phosphoric acids or other nitrogen-containing flame retardants and optionally reinforcers and/or further additives. These are notable fora reliable UL 94 V-0 classification, elevated glow wire resistance, improved mechanical properties and reduced polymer degradation.

Further flame retardant polyester compounds having this profile of properties are disclosed in DE 10 2010 049 968 A1. These compounds comprise thermoplastic polyester, phosphinic salt, phosphazene and optionally reaction products of melamine with phosphoric acid and/or condensed phosphoric acids or other nitrogen-containing flame retardants and optionally reinforcers and/or further additives.

However, there has to date been a lack of flame-retardant phosphinate-containing polyester compositions that simultaneously attain all the required properties, such as good electrical values and effective flame retardancy, and also simultaneously good demoldability and a smooth surface of the molding.

It was therefore an object of the present invention to provide flame-retardant polyester compositions based on phosphinate-containing flame retardant systems which simultaneously have all the aforementioned properties, and especially good electrical values (GWFI, GWIT, CTI) and effective flame retardancy (UL-94), and simultaneously good demoldability and a smooth surface of the molding (surface).

Since waxes can typically form exudations which cause rough surfaces, the results found relating to the smooth surface of the moldings are particularly inventive.

The invention provides a flame-retardant polyester composition comprising
thermoplastic polyester as component A,
fillers and/or reinforcers, preferably glass fibers, as component B,
phosphinic salt of the formula (I) as component C

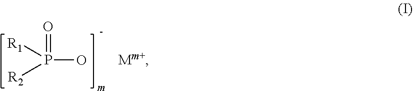

in which R₁ and R₂ are ethyl,
M is Al, Fe, TiOₚ or Zn,
m is 2 to 3, preferably 2 or 3, and
p=(4−m)/2,
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D
phosphonic salt of the formula (II) as component E

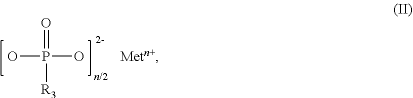

in which R₃ is ethyl,
Met is Al, Fe, TiO_{q} or Zn,
n is 2 to 3, preferably 2 or 3, and
q=(4−n)/2,
inorganic phosphonate as component F, and
wax selected from the group consisting of the polyolefin waxes, amide waxes, natural waxes, long-chain aliphatic carboxylic acids (fatty acids) and/or esters or salts thereof as component G.

In the polyester composition of the invention, the proportion of component A is typically 25% to 95% by weight, preferably 25% to 75% by weight.

In the polyester composition of the invention, the proportion of component B is typically 1% to 45% by weight, preferably 20% to 40% by weight.

In the polyester composition of the invention, the proportion of component C is typically 1% to 35% by weight, preferably 5% to 20% by weight.

In the polyester composition of the invention, the proportion of component D is typically 0.01% to 3% by weight, preferably 0.05% to 1.5% by weight.

In the polyester composition of the invention, the proportion of component E is typically 0.001% to 1% by weight, preferably 0.01% to 0.6% by weight.

In the polyester composition of the invention, the proportion of component F is typically 0.005% to 6% by weight, preferably 0.05% to 2% by weight.

In the polyester composition of the invention, the proportion of component G is typically 0.05% to 5% by weight, preferably 0.1% to 2% by weight.

These percentages for the proportions of components A to G are based on the total amount of the polyester composition.

Preference is given to flame-retardant polyester compositions in which
the proportion of component A is 25% to 95% by weight,
the proportion of component B is 1% to 45% by weight,
the proportion of component C is 1% to 35% by weight,
the proportion of component D is 0.01% to 3% by weight,
the proportion of component E is 0.001% to 1% by weight,
the proportion of component F is 0.005% to 6% by weight, and
the proportion of component G is 0.05% to 5% by weight,
   where the percentages are based on the total amount of the polyester composition.

Particular preference is given to flame-retardant polyester composition in which
the proportion of component A is 25% to 75% by weight,
the proportion of component B is 20% to 40% by weight,
the proportion of component C is 5% to 20% by weight,
the proportion of component D is 0.05% to 1.5% by weight,
the proportion of component E is 0.01% to 0.6% by weight,
the proportion of component F is 0.05% to 2% by weight, and
the proportion of component G is 0.1% to 2% by weight.

Salts of component C that are used with preference are those in which M^{m+} is Zn²⁺, Fe³⁺ or especially Al³⁺.

Salts of component D that are used with preference are zinc, iron or especially aluminum salts.

Salts of component E that are used with preference are those in which Metⁿ⁺ is Zn²⁺, Fe³⁺ or especially Al³⁺.

Very particular preference is given to flame-retardant polyester compositions in which M and Met are Al, m and n are 3, and in which the compounds of components D and F take the form of aluminum salts.

In a further preferred embodiment, the above-described flame-retardant polyester compositions contain iron in an amount within the range from 0.0001% to 0.2% by weight, preferably from 0.0002% to 0.05% by weight. The iron may be in elemental form or in the form of an iron-containing alloy. However, the iron is preferably in the form of an iron-containing substance, i.e. in the form of an anionic or nonionic iron compound. For example iron may be in the form of a cationic component in components C, D, E and/or F, or other iron salts or else iron complexes may also be used.

It has been found that, surprisingly, the polyester compositions of the invention, in the presence of iron, have a broadened processing window in compounding and injection molding, and also improved thermal stability, with simultaneously good flame retardancy.

More preferably, the flame retardant components C) to F) are in the form of a physical mixture with iron-containing compounds.

Likewise more preferably, at least one of the flame retardant components C), D), E) and F) comprises iron.

Preferably, the iron compounds for production of the polyester compositions of the invention are iron(II) and/or iron(III) salts.

In a further preferred embodiment, the polyester composition of the invention comprises a melamine polyphosphate having an average degree of condensation of 2 to 200 as component H.

The use of the polyphosphate derivatives of melamine having a degree of condensation of not less than 20 that are used in accordance with the invention as component H as flame retardants is known. For instance, DE 10 2005 016 195 A1 discloses a stabilized flame retardant comprising 99% to 1% by weight of melamine polyphosphate and 1% to 99% by weight of additive with reserve alkalinity. This document also discloses that this flame retardant can be combined with a phosphinic acid and/or a phosphinic salt.

Preferred flame-retardant polyester compositions of the invention comprise, as component H, a melamine polyphosphate having an average degree of condensation of 20 to 200, especially of 40 to 150.

In another preferred range, the average degree of condensation is 2 to 100.

Further preferred flame-retardant polyester compositions of the invention comprise, as component H, a melamine polyphosphate having a breakdown temperature of not less than 320° C., especially of not less than 360° C. and most preferably of not less than 400° C.

Preference is given to using, as component H, melamine polyphosphates that are known from WO 2006/027340 A1 (corresponding to EP 1 789 475 B1) and WO 2000/002869 A1 (corresponding to EP 1 095 030 B1).

Preference is given to using melamine polyphosphates having an average degree of condensation between 20 and 200, especially between 40 and 150, and having a melamine content of 1.1 to 2.0 mol, especially 1.2 to 1.8 mol, per mole of phosphorus atom.

Preference is likewise given to using melamine polyphosphates having an average degree of condensation (number-average) of >20, the breakdown temperature of which is greater than 320° C., the molar ratio of 1,3,5-triazine compound to phosphorus of which is less than 1.1, especially 0.8 to 1.0, and the pH of a 10% slurry of which in water at 25° C. is 5 or higher, preferably 5.1 to 6.9.

In the polyester composition of the invention, the proportion of component H is typically between 0% and 25% by weight, preferably 1% to 25% by weight, especially 2% to 10% by weight, based on the total amount of the polyester composition.

In a further preferred embodiment, the polyester composition of the invention comprises melamine cyanurate as component I.

Melamine cyanurate, used as component I in accordance with the invention, is known as a synergist in connection with diethylphosphinate in flame retardants for polymeric molding compounds, for example from WO 97/39053 A1.

In the polyester composition of the invention, the proportion of component I is typically 0% to 25% by weight, preferably 1% to 25% by weight, especially 4% to 10% by weight, based on the total amount of the polyester composition.

Preference is given to flame-retardant polyester compositions of the invention that have a comparative tracking index, measured according to International Electrotechnical Commission Standard IEC-60112/3, of not less than 500 volts.

Likewise preferred flame-retardant polyester compositions of the invention attain a V-0 assessment according to UL-94, especially measured on moldings of thickness 3.2 mm to 0.4 mm.

Further preferred flame-retardant polyester compositions of the invention have a glow wire flammability index according to IEC-60695-2-12 of not less than 960° C., especially measured on moldings of thickness 0.75-3 mm.

Further preferred flame-retardant polyester compositions of the invention have a glow wire resistance, expressed by the glow wire ignition temperature (GWIT) according to IEC-60695-2-13 of at least 775° C., especially measured on moldings of thickness 0.75-3 mm.

The flame retardant combinations used in accordance with the invention give a very good stabilization of the polyester (component A) against thermal degradation. This is shown by the change in the specific viscosity of the polyester on compounding and shaping of the polyester compositions of the invention. The thermal stress therein results in partial degradation of the polyester chains, which is expressed in a reduction in the average molecular weight and in an associated decrease in the viscosity of a polyester solution. Typical values for the specific viscosity of polybutylene terephthalate, measured as a 0.5% solution in phenol/dichlorobenzene (1:1) at 25° C. according to ISO 1628 with a capillary viscometer are 130 cm³/g. After the compounding and shaping of a polybutylene terephthalate composition of the invention, typical values for the specific viscosity of the processed polybutylene terephthalate (ascertained as specified above) are in the range between 65 and 150 cm³/g, preferably between 100 and 129 cm³/g.

The polyester compositions of the invention comprise one or more thermoplastic polyesters as component A.

The polyesters of component A are generally (cyclo)aliphatic or aromatic-aliphatic polyesters which derive from (cyclo)aliphatic and/or aromatic dicarboxylic acids or the polyester-forming derivatives thereof, such as the dialkyl esters or anhydrides thereof, and from (cyclo)aliphatic and/or araliphatic diols or from (cyclo)aliphatic and/or aromatic hydroxycarboxylic acids or the polyester-forming derivatives thereof, such as the alkyl esters or anhydrides thereof. The term “(cyclo)aliphatic” encompasses cycloaliphatic and aliphatic compounds.

The thermoplastic polyesters of component A are preferably selected from the group of the polyalkylene esters of aromatic and/or aliphatic dicarboxylic acids or the dialkyl esters thereof.

The thermoplastic polyesters used as component A can be prepared by known methods (Kunststoff-Handbuch [Plastics Handbook], vol. VIII, pages 695-710, Karl-Hanser-Verlag, Munich 1973).

Components A used with preference are aromatic-aliphatic thermoplastic polyesters and, among these, preferably thermoplastic polyesters derived by reaction of aromatic dicarboxylic acids or the polyester-forming derivatives thereof with aliphatic C₂-C₁₀ diols, especially with C₂-C₄ diols.

Components A used with preference in accordance with the invention are polyalkylene terephthalates, and among these more preferably polyethylene terephthalates or polybutylene terephthalates.

Polyalkylene terephthalates contain preferably at least 80 mol %, especially 90 mol %, based on the dicarboxylic acid, of units derived from terephthalic acid.

The polyalkylene terephthalates used with preference in accordance with the invention as component A may, as well as the terephthalic acid radicals, contain up to 20 mol % of radicals of other aromatic dicarboxylic acids having 8 to 14 carbon atoms or radicals of aliphatic dicarboxylic acids having 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid or azelaic acid, cyclohexanediacetic acid or cyclohexanedicarboxylic acid.

The polyalkylene terephthalates used with preference in accordance with the invention as component A may be branched by incorporation of relatively small amounts of tri- or tetrahydric alcohols or tri- or tetrabasic carboxylic acids, as described, for example, in DE-A 19 00 270. Examples of preferred branching agents are trimesic acid, trimellitic acid, trimethylolethane and -propane and pentaerythritol.

Particularly preferred components A are polyalkylene terephthalates that are prepared solely from terephthalic acid and the reactive derivatives thereof (for example the dialkyl esters thereof) and ethylene glycol and/or propane-1,3-diol and/or butane-1,4-diol (polyethylene terephthalate and polytrimethylene terephthalate and polybutylene terephthalate) and mixtures of these polyalkylene terephthalates.

Preferred polybutylene terephthalates contain at least 80 mol %, preferably 90 mol %, based on the dicarboxylic acid, of terephthalic acid radicals and at least 80 mol %, preferably at least 90 mol %, based on the diol component, of butane-1,4-diol radicals.

The preferred polybutylene terephthalates may additionally contain, as well as butane-1,4-diol radicals, up to 20 mol % of other aliphatic diols having 2 to 12 carbon atoms or cycloaliphatic diols having 6 to 21 carbon atoms, for example radicals of ethylene glycol; propane-1,3-diol, 2-ethylpropane-1,3-diol, neopentyl glycol; pentane-1,5-diol, hexane-1,6-diol, cyclohexane-1,4-dimethanol, 3-methylpentane-2,4-diol; 2-methylpentane-2,4-diol; 2,2,4-trimethylpentane-1,3-diol; 2-ethylhexane-1,3-diol, 2,2-diethylpropane-1,3-diol, hexane-2,5-diol; 1,4-di([beta]-hydroxyethoxy)benzene, 2,2-bis(4-hydroxycyclohexyl)propane; 2,4-dihydroxy-1,1,3,3-tetramethylcyclobutane, 2,2-bis(3-[beta]-hydroxyethoxyphenyl)propane and 2,2-bis(4-hydroxypropoxyphenyl)propane.

Polyalkylene terephthalates used with preference in accordance with the invention as component A are also copolyesters that are prepared from at least two of the abovementioned acid components and/or from at least two of the abovementioned alcohol components and/or butane-1,4-diol.

The thermoplastic polyesters used in accordance with the invention as component A can also be used in a mixture with other polyesters and/or further polymers.

Fillers and/or especially reinforcers, preferably glass fibers, are used as component B. It is also possible to use mixtures of two or more different fillers and/or reinforcers.

Preferred fillers are mineral particulate fillers based on talc, mica, silicate, quartz, titanium dioxide, wollastonite, kaolin, amorphous silicas, nanoscale minerals, more preferably montmorillonites or nanoboehmites, magnesium carbonate, chalk, feldspar, glass beads and/or barium sulfate. Particular preference is given to mineral particulate fillers based on talc, wollastonite and/or kaolin.

Particular preference is further also given to using acicular mineral fillers. Acicular mineral fillers are understood in accordance with the invention to mean a mineral filler having highly pronounced acicular character. Preference is given to acicular wollastonites. Preferably, the mineral has a length to diameter ratio of 2:1 to 35:1, more preferably of 3:1 to 19:1, especially preferably of 4:1 to 12:1. The average particle size of the acicular mineral fillers used in accordance with the invention as component B is preferably less than 20 μm, more preferably less than 15 μm, especially preferably less than 10 μm, determined with a CILAS granulometer.

Components B used with preference in accordance with the invention are reinforcers. These may, for example, be reinforcers based on carbon fibers and/or glass fibers.

The filler and/or reinforcer may, in a preferred embodiment, have been surface-modified, preferably with an adhesion promoter or an adhesion promoter system, more preferably one based on silane. Especially in the case of use of glass fibers, in addition to silanes, it is also possible to use polymer dispersions, film formers, branching agents and/or glass fiber processing auxiliaries.

The glass fibers used with preference in accordance with the invention as component B may be short glass fibers and/or long glass fibers. Short or long glass fibers used may be chopped fibers. Short glass fibers may also be used in the form of ground glass fibers. In addition, glass fibers may also be used in the form of continuous fibers, for example in the form of rovings, monofilaments, filament yarns or threads, or glass fibers may be used in the form of textile fabrics, for example as a glass weave, a glass braid or a glass mat.

Typical fiber lengths for short glass fibers prior to incorporation into the polyester matrix vary within the range from 0.05 to 10 mm, preferably from 0.1 to 5 mm. After incorporation into the polyester matrix, the length of the glass fibers has decreased. Typical fiber lengths for short glass fibers after incorporation into the polyester matrix vary within the range from 0.01 to 2 mm, preferably from 0.02 to 1 mm.

The diameters of the individual fibers may vary within wide ranges. Typical diameters of the individual fibers vary within the range from 5 to 20 μm.

The glass fibers may have any desired cross-sectional forms, for example round, elliptical, n-gonal or irregular cross sections. It is possible to use glass fibers having mono- or multilobal cross sections.

Glass fibers may be used in the form of continuous fibers or in the form of chopped or ground glass fibers.

The glass fibers themselves, irrespective of their cross-sectional area and length, may be selected, for example, from the group of the E glass fibers, A glass fibers, C glass fibers, D glass fibers, M glass fibers, S glass fibers, R glass fibers and/or ECR glass fibers, particular preference being given to the E glass fibers, R glass fibers, S glass fibers and ECR glass fibers. The glass fibers have preferably been provided with a size, preferably containing polyurethane as film former and aminosilane as adhesion promoter.

E glass fibers used with particular preference have the following chemical composition: SiO₂ 50-56%; Al₂O₃ 12-16%; CaO 16-25%; MgO≥6%; B₂O₃ 6-13%; F≤0.7%; Na₂O 0.3-2%; K₂O 0.2-0.5%; Fe₂O₃ 0.3%.

R glass fibers used with particular preference have the following chemical composition: SiO₂ 50-65%; Al₂O₃ 20-30%; CaO 6-16%; MgO 5-20%; Na₂O 0.3-0.5%; K₂O 0.05-0.2%; Fe₂O₃ 0.2-0.4%; TiO₂ 0.1-0.3%.

ECR glass fibers used with particular preference have the following chemical composition: SiO₂ 57.5-58.5%; Al₂O₃ 17.5-19.0%; CaO 11.5-13.0%; MgO 9.5-11.5%.

The salts of diethylphosphinic acid used in accordance with the invention as component C are known flame retardants for polymeric molding compounds.

Salts of diethylphosphinic acid with proportions of the phosphinic and phosphonic salts used in accordance with the invention as components D and E are also known flame retardants. The preparation of these combinations of substances is described, for example, in U.S. Pat. No. 7,420,007 B2.

The salts of diethylphosphinic acid of component C that are used in accordance with the invention may contain small amounts of salts of component D and of salts of component E, for example up to 10% by weight of component D, preferably 0.01% to 6% by weight, and especially 0.2% to 2.5% by weight thereof, and up to 10% by weight of component E, preferably 0.01% to 6% by weight, and especially 0.2% to 2.5% by weight thereof, based on the amounts of components C, D and E.

The salts of ethylphosphonic acid used in accordance with the invention as component E are likewise known as additions to diethylphosphinates in flame retardants for polymeric molding compounds, for example from DE 102007041594 A1.

The use of the inorganic phosphonates used in accordance with the invention as component F or else of salts of phosphorous acid (phosphites) as flame retardants is known. For instance, WO 2012/045414 A1 discloses flame retardant combinations comprising, as well as phosphinic salts, also salts of phosphorous acid (=phosphites).

Preferably, the inorganic phosphonate (component F) conforms to the general formula (IV) or (V)

[(HO)PO₂]²⁻_{p/2} Kat (IV)

[(HO)₂PO]⁻ₚKat^{p+} (V)

in which Kat is a p-valent cation, especially a cation of an alkali metal or alkaline earth metal, an ammonium cation and/or a cation of Fe, Zn or especially of Al, including the cations Al(OH) or Al(OH)₂, and p is 1, 2, 3 or 4.

Preferably, the inorganic phosphonate (component F) is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)^{3*}xAl₂O₃*nH₂O where x=2.27−1 and/or Al₄H₆P₁₆O₁₈.

The inorganic phosphonate (component F) preferably also comprises aluminum phosphites of the formulae (VI), (VII) and/or (VIII)

Al₂(HPO₃)₃×(H₂O)_{q} (VI)

where q is 0 to 4,

Al_{2.00}M_{z}(HPO₃)_{y}(OH)ᵥ×(H₂O)_{w} (VII)

where M represents alkali metal cations, z is 0.01 to 1.5 and y is 2.63 to 3.5 and v is 0 to 2 and w is 0 to 4;

Al_{2.00}(HPO₃)ᵤ(H₂PO₃)ₜ×(H₂O)ₛ (VIII)

where u is 2 to 2.99 and t is 2 to 0.01 and s is 0 to 4,
and/or
aluminium phosphite [Al(H2PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O where x=2.27−1 and/or Al₄H₆P₁₆O₁₈.

Preferred inorganic phosphonates (component F) are salts that are insoluble or sparingly soluble in water.

Particularly preferred inorganic phosphonates are aluminum, calcium and zinc salts.

More preferably, component F is a reaction product of phosphorous acid and an aluminum compound.

Particularly preferred components F are aluminum phosphites having CAS numbers 15099-32-8, 119103-85-4, 220689-59-8, 56287-23-1, 156024-71-4 and 71449-76-8.

The aluminum phosphites used with preference are prepared by reaction of an aluminum source with a phosphorus source and optionally a template in a solvent at 20-200° C. over a period of time of up to 4 days. For this purpose, aluminum source and phosphorus source are mixed for 1-4 h, heated under hydrothermal conditions or at reflux, filtered off, washed and dried, for example at 110° C.

Preferred aluminum sources are aluminum isopropoxide, aluminum nitrate, aluminum chloride, aluminum hydroxide (e.g. pseudoboehmite).

Preferred phosphorus sources are phosphorous acid, (acidic) ammonium phosphite, alkali metal phosphites or alkaline earth metal phosphites.

Preferred alkali metal phosphites are disodium phosphite, disodium phosphite hydrate, trisodium phosphite, potassium hydrogenphosphite.

A preferred disodium phosphite hydrate is Brüggolen® H10 from Brüggemann.

Preferred templates are 1,6-hexanediamine, guanidine carbonate or ammonia. A preferred alkaline earth metal phosphite is calcium phosphite.

The preferred ratio of aluminum to phosphorus to solvent is 1:1:3.7 to 1:2.2:100 mol. The ratio of aluminum to template is 1:0 to 1:17 mol. The preferred pH of the reaction solution is 3 to 9. A preferred solvent is water.

In the application, particular preference is given to using the same salt of phosphinic acid as of phosphorous acid, i.e., for example, aluminum diethylphosphinate together with aluminum phosphite or zinc diethylphosphinate together with zinc phosphite.

In a preferred embodiment, the above-described flame-retardant polyester compositions comprise, as component F, a compound of the formula (III)

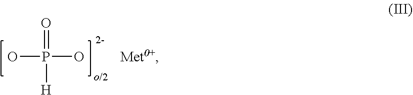

in which Me is Fe, TiOᵣ, Zn or especially Al,
o is 2 to 3, preferably 2 or 3, and
r=(4−o)/2.

Compounds of the formula (III) that are used with preference are those in which Me⁰⁺ is Zn²⁺, Fe³⁺ or especially Al³⁺.

In a further preferred embodiment, components C, D, E, F, H and I are in particulate form, where the median particle size (d₅₀) is 1 to 100 μm.

The waxes added as component G in accordance with the invention are compounds known per se; these are selected from the group of the polyolefin waxes, amide waxes, natural waxes, long-chain aliphatic carboxylic acids (fatty acids) and/or esters or salts thereof.

The waxes used in accordance with the invention as component G may be used either as such or in polar-modified form. Polar modification can be achieved, for example, by oxidation with air or with oxygenous gases or by grafting with, for example, unsaturated carboxylic acids, for instance maleic acid. Examples of oxidative modification can be found in EP 0 890 583 A1. Examples of modification with unsaturated carboxylic acids can be found in EP 0 941 257 B1.

It is also possible to use mixtures of different waxes.

Examples of polyolefin waxes used in accordance with the invention as component G are those which can be obtained by the polymerization of one or more α-olefins, especially with metallocene catalysts. Examples of metallocenes and the use thereof for production of polyolefin waxes can be found, for example, in EP 0 571 882 A2.

Polyolefin waxes used with preference as component G are PE waxes, PTFE waxes, PP waxes, FT paraffins, macro- and microcrystalline paraffins and polar polyolefin waxes.

Examples of PE waxes are polyethylene homo- and copolymer waxes which have been produced especially by means of metallocene catalysis, and which have a number-average molecular weight of 700 to 10 000 g/mol with a dripping point between 80 and 140° C.

Examples of PTFE waxes are polytetrafluoroethylenes having a molecular weight between 30 000 and 2 000 000 g/mol, especially between 100 000 and 1 000 000 g/mol.

Examples of PP waxes are polypropylene homo- and copolymer waxes which have especially been produced by means of metallocene catalysis, and which have a number-average molecular weight of 700 to 10 000 g/mol with a dripping point between 80 and 160° C.

Examples of FT waxes are Fischer-Tropsch paraffins (FT paraffins) having a number-average molecular weight of 400 to 800 g/mol with a dripping point of 80 to 125° C.

Examples of macro- and microcrystalline paraffins are paraffins and microcrystalline waxes obtained in crude oil refining. The dripping points of such paraffins are preferably between 45 and 65° C., and that of such microcrystalline waxes is preferably between 73 and 100° C.

Examples of polar polyolefin waxes are compounds preparable by oxidation of ethylene or propylene homopolymer and copolymer waxes or by grafting thereof with maleic anhydride. For this purpose, particular preference is given to polyolefin waxes having a dripping point between 90 and 165° C., especially between 100 and 160° C., a melt viscosity at 140° C. (polyethylene waxes) or at 170° C. (polypropylene waxes) between 10 and 10 000 mPas, especially between 50 and 5000 mPas, and a density at 20° C. between 0.85 and 0.96 g/cm3.

Waxes used with particular preference as component G are amide waxes. These are waxes producible by reaction of ammonia or alkylenediamine, such as ethylene-diamine or hexamethylenediamine, with saturated and/or unsaturated fatty acids. Fatty acids are long-chain carboxylic acids having preferably 14 to 40 carbon atoms, for example stearic acid, tallow fatty acid, palmitic acid or erucic acid.

Further waxes used with preference as component G are natural waxes. These are, for example, carnauba wax or candelilla wax.

Further waxes used with preference as component G are long-chain aliphatic carboxylic acids (fatty acids) and/or esters or salts thereof, especially of aliphatic carboxylic acids having chain lengths of 014 to 040.

Examples of acid and ester waxes are montan waxes. These comprise fatty acids and esters thereof having a carbon chain length of the carboxylic acid of C₂₂ to C₃₆.

Preferred ester waxes are reaction products of montan wax acids with mono- or polyhydric alcohols having 2 to 6 carbon atoms, for example ethanediol, butane-1,3-diol, propane-1,2,3-triol or pentaerythritol.

Further examples of ester waxes used with preference are sorbitan esters. These are reaction products of sorbitol with saturated and/or unsaturated fatty acids and/or montanic acids, for example with stearic acid, tallow fatty acid, palmitic acid or erucic acid.

Waxes used with particular preference as component G are esters or salts of long-chain aliphatic carboxylic acids (fatty acids) typically having chain lengths of C₁₄ to C₄₀. The esters are reaction products of the carboxylic acids mentioned with commonly used polyhydric alcohols, for example ethylene glycol, glycerol, trimethylolpropane or pentaerythritol. Useful salts of the carboxylic acids mentioned particularly include alkali metal, alkaline earth metal, aluminum or zinc salts.

Most preferably, component G comprises esters or salts of stearic acid, for example glyceryl monostearate or pentaerythritol tetrastearate, or calcium, aluminum or zinc stearate.

Most preferably, component G comprises reaction products of montan wax acids with alkylene glycol, especially with ethylene glycol.

Especially preferred among these are mixtures of ethylene glycol mono-montan wax ester, ethylene glycol di-montan wax ester, montan wax acids and ethylene glycol.

Component G likewise more preferably comprises reaction products of montan wax acids with a calcium, aluminum or zinc salt.

More preferably, the reaction products are a mixture of butane-1,3-diol mono-montan wax ester, butane-1,3-diol di-montan wax ester, montan wax acids, butane-1,3-diol, calcium montanate and the calcium salt.

In a further preferred embodiment, component G comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols, such as ethylene glycol, glycerol, trimethylolpropane and/or pentaerythritol.

The polyester compositions of the invention may also comprise further additives as component J. Preferred components J in the context of the present invention are antioxidants, UV stabilizers, gamma ray stabilizers, hydrolysis stabilizers, costabilizers for antioxidants, antistats, emulsifiers, nucleating agents, plasticizers, processing auxiliaries, impact modifiers, dyes, pigments and/or further flame retardants other than components C, D, E, F, H and I.

These especially include phosphates, for instance melamine poly(metal phosphates). Preferred metals for this purpose are the elements of main group 2, of main group 3, of transition group 2, of transition group 4 and of transition group Villa of the Periodic Table, and also cerium and/or lanthanum.

Melamine poly(metal phosphates) are preferably melamine poly(zinc phosphates), melamine poly(magnesium phosphates) and/or melamine poly(calcium phosphates).

Preference is given to (melamine)₂Mg(HPO₄)₂, (melamine)₂Ca(HPO₄)₂, (melamine)₂Zn(HPO₄)₂, (melamine)₃Al(HPO₄)₃, (melamine)₂Mg(P₂O₇), (melamine)₂Ca(P₂O₇), (melamine)₂Zn(P₂O₇), (melamine)₃Al(P₂O₇)_{3/2}.

Preference is given to melamine poly(metal phosphates) that are known as hydrogenphosphato- or pyrophosphatometalates with complex anions having a tetra- or hexavalent metal atom as coordination site with bidentate hydrogenphosphate or pyrophosphate ligands.

Preference is also given to melamine-intercalated aluminum, zinc or magnesium salts of condensed phosphates, very particular preference to bismelamine zincodiphosphate and/or bismelamine aluminotriphosphate.

Preference is further given to salts of the elements of main group 2, of main group 3, of transition group 2, of transition group 4 and of transition group Villa of the Periodic Table and of cerium and/or lanthanum with anions of the oxo acids of the fifth main group (phosphates, pyrophosphates and polyphosphates).

Preference is given to aluminum phosphates, aluminum monophosphates, aluminum orthophosphates (AlPO₄), aluminum hydrogenphosphate (Al₂(HPO₄)₃) and/or aluminum dihydrogenphosphate.

Preference is also given to calcium phosphate, zinc phosphate, titanium phosphate and/or iron phosphate.

Preference is given to calcium hydrogenphosphate, calcium hydrogenphosphate dihydrate, magnesium hydrogenphosphate, titanium hydrogenphosphate (TIHC) and/or zinc hydrogenphosphate.

Preference is given to aluminum dihydrogenphosphate, magnesium dihydrogenphosphate, calcium dihydrogenphosphate, zinc dihydrogenphosphate, zinc dihydrogenphosphate dihydrate and/or aluminum dihydrogenphosphate.

Particular preference is given to calcium pyrophosphate, calcium dihydrogenpyrophosphate, magnesium pyrophosphate, zinc pyrophosphate and/or aluminum pyrophosphate.

The aforementioned phosphates and other and similar phosphates are supplied, for example, by J. M. Huber Corporation, USA, as Safire® Products; these include, for instance, the APP Type II, AMPP, MPP, MPyP, PiPyP, PPaz, Safire® 400, Safire® 600, EDAP products inter alia.

Further phosphates are, for example, those mentioned in JP-A-2004204194, DE-A-102007036465 and EP-A-3133112, which are explicitly included among the aforementioned usable components.

The further additives are known per se as additions to polyester compositions and can be used alone or in a mixture or in the form of masterbatches.

The aforementioned components A, B, C, D, E, F, G and optionally H, I and J may be processed in a wide variety of different combinations to give the flame-retardant polyester composition of the invention. For instance, it is possible, at the start or at the end of the polycondensation or in a subsequent compounding operation, to mix the components into the polyester melt. In addition, there are processing operations in which individual components are not added until a later stage. This is practiced especially in the case of use of pigment or additive masterbatches. There is also the possibility of applying components, particularly those in pulverulent form, to the polymer pellets, which may be warm as a result of the drying operation, by drum application.

It is also possible to combine two or more of the components of the polyester compositions of the invention by mixing before they are introduced into the polyester matrix. It is possible here to use conventional mixing units in which the components are mixed in a suitable mixer, for example at 0 to 300° C. for 0.01 to 10 hours.

It is also possible to use two or more of the components of the polyester compositions of the invention to produce pellets that can then be introduced into the polyester matrix.

For this purpose, two or more components of the polyester composition of the invention can be processed with pelletizing aids and/or binders in a suitable mixer or a dish pelletizer to give pellets.

The crude product formed at first can be dried in a suitable drier or heat-treated to further increase the grain size.

The polyester composition of the invention or two or more components thereof may, in one embodiment, be produced by roll compaction.

The polyester composition of the invention or two or more components thereof may, in one embodiment, be produced by subjecting the ingredients to mixing, extruding, chopping (and optionally crushing and classifying) and drying (and optionally coating).

The polyester composition of the invention or two or more components thereof may, in one embodiment, be produced by spray granulation.

The flame-retardant polymer molding composition of the invention is preferably in pellet form, for example in the form of an extrudate or compound. The pelletized material is preferably in cylindrical form with a circular, elliptical or irregular footprint, in bead form, in cushion form, in cube form, in cuboid form or in prism form.

Typical length-to-diameter ratios of the pelletized material are 1:50 to 50:1, preferably 1:5 to 5:1.

The pelletized material preferably has a diameter of 0.5 to 15 mm, more preferably of 2 to 3 mm, and preferably a length of 0.5 to 15 mm, more preferably of 2 to 5 mm.

The invention also provides moldings produced from the above-described flame-retardant polyester composition comprising components A, B, C, D, E, F and G and optionally component(s) H, I and J.

The moldings of the invention may be in any desired shape and form. Examples of these are fibers, films or shaped bodies obtainable from the flame-retardant polyester molding compounds of the invention by any desired shaping processes, especially by injection molding or extrusion.

The flame-retardant shaped polyester bodies of the invention can be produced by any desired shaping methods. Examples of these are injection molding, pressing, foam injection molding, internal gas pressure injection molding, blow molding, film casting, calendering, laminating or coating at relatively high temperatures with the flame-retardant polyester molding compound.

The moldings are preferably injection moldings or extrudates.

The flame-retardant polyester compositions of the invention are suitable for production of fibers, films and shaped bodies, especially for applications in the electricals and electronics sector.

The invention preferably relates to the use of the flame-retardant polyester compositions of the invention in or for plug connectors, current-bearing components in power distributors (residual current protection), printed circuit boards, potting compounds, power connectors, circuit breakers, lamp housings, LED housings, capacitor housings, coil elements and ventilators, grounding contacts, plugs, in/on printed circuit boards, housings for plugs, cables, flexible circuit boards, charging cables for mobile phones, motor covers or textile coatings.

The invention likewise preferably relates to the use of the flame-retardant polyester compositions of the invention for production of shaped bodies in the form of components for the electrics/electronics sector, especially for parts of printed circuit boards, housings, films, wires, switches, distributors, relays, resistors, capacitors, coils, lamps, diodes, LEDs, transistors, connectors, regulators, memory elements and sensors, in the form of large-area components, especially of housing components for switchgear cabinets and in the form of components of complicated configuration with demanding geometry.

The wall thickness of the shaped bodies of the invention may typically be up to 10 mm. Particularly suitable shaped bodies are those having a wall thickness of less than 1.5 mm, more preferably a wall thickness of less than 1 mm and especially preferably a wall thickness of less than 0.5 mm.

The examples which follow elucidate the invention without restricting it.

1. Components used

Commercial polyesters (component A):

polybutylene terephthalate (PBT): Ultradur® 4500 (BASF)

polyethylene terephthalate (PET): Polyclear® 1100 (Invista)

Glass fibers (component B):

Vectrotex® EC 10 P 952 glass fibers (from Vectrotex, FR)

Flame retardant FM 1 (componens C, D and E):

aluminum salt of diethylphosphinic acid containing 0.9 mol % of aluminum ethylbutylphosphinate and 0.5 mol % of aluminum ethylphosphonate prepared according to example 3 of U.S. Pat. No. 7,420,007 B2

Flame retardant FM 2 (components C, D and E):

aluminum salt of diethylphosphinic acid containing 2.7 mol % of aluminum ethylbutylphosphinate and 0.8 mol % of aluminum ethylphosphonate prepared according to example 4 of U.S. Pat. No. 7,420,007 B2

Flame retardant FM 3 (components C, D and E):

aluminum salt of diethylphosphinic acid containing 0.5 mol % of aluminum ethylbutylphosphinate and 0.05 mol % of aluminum ethylphosphonate prepared by the process according to U.S. Pat. No. 7,420,007 B2

Flame retardant FM 4 (components C, D and E):

aluminum salt of diethylphosphinic acid containing 10 mol % of aluminum ethylbutylphosphinate and 5 mol % of aluminum ethylphosphonate prepared by the process according to U.S. Pat. No. 7,420,007 B2

Flame retardant FM 5 (component C):

aluminum salt of diethylphosphinic acid prepared in analogy to example 1 of DE 196 07 635 A1

Flame retardant FM 6 (components C and E):

aluminum salt of diethylphosphinic acid containing 8.8 mol % of aluminum ethylphosphonate

Flame retardant FM 7 (component F):

aluminum salt of phosphonic acid prepared according to example 1 of DE 102011120218 A1

Flame retardant FM 8 (component F):

aluminum salt of phosphorous acid

Flame retardant FM 9 (component H):

melamine polyphosphate prepared according to the example of WO2000/002869 A1

Flame retardant FM 10 (component I):

melamine cyanurate, Melapur® MC (BASF)

Wax 1 (component G):

Licomont® CaV 102 (calcium salt of montan wax acid), from Clariant Produkte (Deutschland) GmbH

Wax 2 (component G):

Licowax® E (esters of montan wax acid), from Clariant Produkte (Deutschland) GmbH

2. Production, Processing and Testing of Flame-Retardant Polyester Molding Compounds

The flame retardant components were mixed with the polymer pellets and the wax in the ratios specified in the tables and incorporated in a twin-screw extruder (Leistritz ZSE 27 HP-44D) at temperatures of 240 to 280° C. The glass fibers were added via a side intake. The homogenized polymer strand was drawn off, cooled in a water bath and then pelletized.

After sufficient drying, the molding compositions were processed to test specimens on an injection molding machine (Arburg 320 C/KT) at melt temperatures of 260 to 280° C., and tested and classified for flame retardancy using the UL 94 test (Underwriter Laboratories). As well as the classification, the afterflame time was also reported.

The comparative tracking index of the moldings was determined according to International Electrotechnical Commission Standard IEC-60112/3.

The glow wire flammability index (GWFI index) was determined according to standard IEC-60695-2-12.

The glow wire ignition temperature (GWIT index) was determined according to standard IEC-60695-2-13.

In the GWFI test, using 3 test specimens (for example using sheets of geometry 60×60×1.5 mm), with the aid of a glow wire, at temperatures between 550 and 960° C., the maximum temperature at which an afterflame time of 30 seconds is not exceeded and the sample does not give off burning drops is determined. In the GWIT test, in a comparable measurement procedure, the glow wire ignition temperature 25 K higher (30 K higher between 900° C. and 960° C.) than the maximum glow wire temperature that does not lead to ignition in 3 successive tests even during the contact time of the glow wire is reported. Ignition is regarded here as a flame having a burning time of 5 sec.

The consistency of the surface of the molding was assessed visually.

All tests in the respective series, unless stated otherwise, were performed under identical conditions (such as temperature programs, screw geometry and injection molding parameters) for comparability.

### EXAMPLES 1-6 AND COMPARATIVE EXAMPLES C1-C10 WITH PBT

The results of the experiments with PBT molding compounds are listed in the examples adduced in the table which follows. All amounts are reported as % by weight and are based on the PBT molding compound including the flame retardants, additives and reinforcers.

TABLE 1
PA 6,6 GF 30 Test results (1-6 inventive; C1-C10 comparisons)

| Example No. | 1 | 1a | 1b | C1 | 2 | C2 | 3 | C3 | 4 |
|---|---|---|---|---|---|---|---|---|---|
| A: PBT | 51.3 | 51.8 | 51.8 | 51.5 | 51.3 | 51.5 | 51.3 | 51.5 | 51.3 |
| B: EC10 glass fibers | 30 | 30 | 30 | 30 | 30 | 30 | 30 | 30 | 30 |
| C + D + E: FM 1 | 18 | 12 | 12 | 18 | — | — | — | — | — |
| C + D + E: FM 2 | — | — | — | — | 18 | 18 | — | — | — |
| C + D + E: FM 3 | — | — | — | — | — | — | 18 | 18 | — |
| C + D + E: FM 4 | — | — | — | — | — | — | — | — | 18 |
| C: FM 5 | — | — | — | — | — | — | — | — | — |
| C + E: FM 6 | — | — | — | — | — | — | — | — | — |
| F: FM 7 | — | — | — | — | — | — | — | — | — |
| F: FM 8 | 0.5 | — | — | 0.5 | 0.5 | 0.5 | 0.5 | 0.5 | 0.5 |
| H: FM 9 | — | 6 | — | — | — | — | — | — | — |
| I: FM 10 | — | — | 6 | — | — | — | — | — | — |
| G: wax 1 | 0.2 | 0.2 | 0.2 | — | 0.2 | — | 0.2 | — | 0.2 |
| G: wax 2 | — | — | — | — | — | — | — | — | — |
| UL 94 0.4 mm/[sec.] | V-0/20 | V-0/21 | V-0/24 | V-0/20 | V-0/15 | V-0/15 | V-0/35 | V-0/35 | V-0/20 |
| GWFI [° C.] | 960 | 960 | 960 | 960 | 960 | 960 | 960 | 960 | 960 |
| GWIT [° C.] | 750 | 750 | 750 | 750 | 750 | 750 | 750 | 750 | 750 |
| CTI [volts] | 600 | 600 | 600 | 500 | 600 | 500 | 600 | 500 | 600 |
| Surface | smooth | smooth | smooth | rough*⁾ | smooth | rough*⁾ | smooth | rough*⁾ | smooth |
| Example No. | C4 | 5 | C5 | 6 | C6 | C7 | C8 | C9 | C10 |
| A: PBT | 51.5 | 53.78 | 53.98 | 51.3 | 51.5 | 51.3 | 51.8 | 47.8 | 51.3 |
| B: EC10 glass fibers | 30 | 30 | 30 | 30 | 30 | 30 | 30 | 30 | 30 |
| C + D + E: FM 1 | — | — | — | — | — | — | — | — | — |
| C + D + E: FM 2 | — | 16 | 16 | 18 | 18 | — | 18 | 22 | — |
| C + D + E: FM 3 | — | — | — | — | — | — | — | — | — |
| C + D + E: FM 4 | 18 | — | — | — | — | — | — | — | — |
| C: FM 5 | — | — | — | — | — | — | — | — | 18 |
| C + E: FM 6 | — | — | — | — | — | 18 | — | — | — |
| F: FM 7 | — | 0.02 | 0.02 | — | — | — | — | — | — |
| F: FM 8 | 0.5 | — | — | 0.5 | 0.5 | 0.5 | — | — | 0.5 |
| H: FM 9 | — | — | — | — | — | — | — | — | — |
| I: FM 10 | — | — | — | — | — | — | — | — | — |
| G: wax 1 | — | 0.2 | — | — | — | 0.2 | 0.2 | 0.2 | 0.2 |
| G: wax 2 | — | — | — | 0.2 | — | — | — | — | — |
| UL 94 0.4 mm/[sec.] | V-0/20 | V-0/05 | V-0/05 | V-0/10 | V-0/10 | V-0/40 | V-2/90 | V-1/75 | V-0/45 |
| GWFI [° C.] | 960 | 960 | 960 | 960 | 960 | 960 | 850 | 900 | 960 |
| GWIT [° C.] | 750 | 750 | 725 | 750 | 700 | 750 | 700 | 725 | 750 |
| CTI [volts] | 500 | 600 | 500 | 550 | 500 | 500 | 600 | 600 | 500 |
| Surface | rough*⁾ | smooth | rough*⁾ | smooth | rough*⁾ | smooth | smooth | smooth | smooth |

*⁾major problems in demolding the molding from the mold

The inventive polyester compositions of examples 1 to 6 are molding compounds which attain the UL 94 V-0 fire class at 0.4 mm, simultaneously have CTI 600 volts/550 volts, GWFI 960° C. and GWIT 750° C., and smooth surfaces. The exchange of wax 2 for wax 1 resulted in an increase in the CTI value. The moldings produced were demoldable without difficulty. The addition of a further component F in example 5 leads to another improvement in flame retardancy, expressed by a reduced afterflame time.

The omission of component G in comparative examples C1 to C6 led to moldings having rough surfaces that were additionally demoldable only with difficulty. Flame-retardancy and GWFI values corresponded to the values for the moldings which contained component G. The CTI values decreased compared to the moldings which contained component G.

The omission of component D in comparative example C7 resulted not only in a prolonged afterflame time compared to examples 1-4 but also in a reduced CTI value.

The omission of component F in comparative example C8 resulted not only in a deterioration in the fire protection class compared to example 2 but also in reduced GWFI and GWIT values.

In comparative example C9, increasing the concentration of components C, D and E resulted in an improvement in the fire protection class compared to example C8. However, this polyester composition still showed a lower fire protection class and reduced GWFI and GWIT values compared to example 2.

The omission of components D and E in comparative example C10 resulted not only in a prolonged afterflame time but in a reduced CTI value compared to examples 1-4.

### EXAMPLES 7-12 AND COMPARATIVE EXAMPLES C11-C20 WITH PET

The results of the experiments with PET molding compounds are listed in the examples adduced in the table below. All amounts are reported as % by weight and relate to the polyester molding compound including the flame retardants, additives and reinforcers.

TABLE 2
PET GF 30 test results (7-12 inventive; C11-C20 comparisons)

| Example No. | 7 | V11 | 8 | V12 | 9 | V13 | 10 | V14 |
|---|---|---|---|---|---|---|---|---|
| A: PET | 57.3 | 57.5 | 57.3 | 57.5 | 57.3 | 57.5 | 57.3 | 57.5 |
| B: EC10 glass fibers | 30 | 30 | 30 | 30 | 30 | 30 | 30 | 30 |
| C + D + E: FM 1 | 12 | 12 | — | — | — | — | — | — |
| C + D + E: FM 2 | — | — | 12 | 12 | — | — | — | — |
| C + D + E: FM 3 | — | — | — | — | 12 | 12 | — | — |
| C + D + E: FM 4 | — | — | — | — | — | — | 12 | 12 |
| C: FM 5 | — | — | — | — | — | — | — | — |
| C + E: FM 6 | — | — | — | — | — | — | — | — |
| F: FM 7 | — | — | — | — | — | — | — | — |
| F: FM 8 | 0.5 | 0.5 | 0.5 | 0.5 | 0.5 | 0.5 | 0.5 | 0.5 |
| G: wax 1 | 0.2 | — | 0.2 | — | 0.2 | — | 0.2 | — |
| G: wax 2 | — | — | — | — | — | — | — | — |
| UL 94 0.4 mm/[sec.] | V-0/18 | V-0/18 | V-0/12 | V-0/12 | V-0/32 | V-0/32 | V-0/16 | V-0/16 |
| GWFI [° C.] | 960 | 960 | 960 | 960 | 960 | 960 | 960 | 960 |
| GWIT [° C.] | 775 | 750 | 775 | 750 | 800 | 750 | 750 | 675 |
| CTI [volts] | 600 | 500 | 600 | 500 | 600 | 500 | 600 | 500 |
| surface | smooth | rough*⁾ | smooth | rough*⁾ | smooth | rough*⁾ | smooth | rough*⁾ |
| Example No. | 11 | V15 | 12 | V16 | V17 | V18 | V19 | V20 |
| A: PET | 57.3 | 57.5 | 57.3 | 57.5 | 57.3 | 57.8 | 52.8 | 57.3 |
| B: EC10 glass fibers | 30 | 30 | 30 | 30 | 30 | 30 | 30 | 30 |
| C + D + E: FM 1 | — | — | — | — | — | — | — | — |
| C + D + E: FM 2 | 10 | 10 | 12 | 12 | — | 12 | 17 | — |
| C + D + E: FM 3 | — | — | — | — | — | — | — | — |
| C + D + E: FM 4 | — | — | — | — | — | — | — | — |
| C: FM 5 | — | — | — | — | — | — | — | 12 |
| C + E: FM 6 | — | — | — | — | 12 | — | — | — |
| F: FM 7 | 2 | 2 | — | — | — | — | — | — |
| F: FM 8 | 0.5 | 0.5 | 0.5 | 0.5 | 0.5 | — | — | 0.5 |
| G: wax 1 | 0.2 | — | — | — | 0.2 | 0.2 | 0.2 | 0.2 |
| G: wax 2 | — | — | 0.2 | — | — | — | — | — |
| UL 94 0.4 mm/[sec.] | V-0/03 | V-0/03 | V-0/08 | V-0/08 | V-0/35 | V-2/85 | V-1/70 | V-0/39 |
| GWFI [° C.] | 960 | 960 | 960 | 960 | 960 | 850 | 900 | 960 |
| GWIT [° C.] | 750 | 750 | 775 | 750 | 750 | 725 | 750 | 750 |
| CTI [volts] | 600 | 500 | 550 | 500 | 500 | 600 | 600 | 500 |
| surface | smooth | rough*⁾ | smooth | rough*⁾ | smooth | smooth | smooth | smooth |

*⁾major problems in demolding the molding from the mold

The inventive polyester compositions of examples 7 to 12 are molding compounds which attain the UL 94 V-0 fire class at 0.4 mm, simultaneously have CTI 600 volts/550 volts, GWFI 960° C. and GWIT 750-775° C., and have smooth surfaces. The replacement of wax 2 by wax 1 resulted in an increase in the CTI value. The moldings produced were demoldable without difficulty. The addition of a further component F in example 11 leads to another improvement in flame retardancy, expressed by a reduced afterflame time.

The omission of component G in comparative examples C11 to C16 led to moldings with rough surfaces that were additionally demoldable only with difficulty. Flame retardancy, GWFI and GWIT values corresponded to the values for the moldings which contained component G. The CTI values decreased compared to the moldings which contained component G.

The omission of component D in comparative example C17 resulted not only in a prolonged afterflame time compared to examples 7-10 but also in a reduced CTI value.

The omission of component F in comparative example C18 resulted not only in a deterioration in fire protection class compared to example 8 but also in reduced GWFI and GWIT values.

In comparative example C19, increasing the concentration of components C, D and E compared to example C18 did achieve an improvement in the fire protection class. However, this polyester composition still exhibited a lower fire protection class and reduced GWFI and GWIT values compared to example 8.

The omission of components D and E in comparative example C20 resulted not only in a prolonged afterflame time compared to examples 7-10 but also in a reduced CTI value.

### EXAMPLES 13-15

Production, processing and testing of flame-retardant polyester molding compounds and polyester moldings were effected as described in examples 1-12 and C1-C20. In accordance with the aforementioned general method, flame-retardant polyamide molding compounds and flame-retardant polyester moldings were produced.

The composition thereof was 51.3% by weight of polybutylene terephthalate (Ultradur® 4500), 30% by weight of glass fibers (Vectrotex® EC 10 P 952), 18% by weight of flame retardants used in accordance with the invention of components C, D and E according to the details above, 0.5% by weight of aluminum salt of phosphorous acid, and 0.2% by weight of wax (Licowax® E).

The thermal stability of the polyester compositions examined was ascertained with the aid of thermogravimetry (TGA). The temperature reported is that at which there was a weight loss of 2% by weight.

The processing window of the polyester compositions examined was likewise determined by TGA. This is done by measuring the weight loss in % by weight at 330° C. after 1 h. TGA is conducted under an air atmosphere.

Since the lower limit of the processing window is unaffected, the measure determined for the processing window is the breakdown of the flame-retardant polyester molding compound at the upper limit. This is done using the weight loss at a defined temperature.

### EXAMPLE 13

The flame retardant used was the above-described FM 2, which consisted of components C), D) and E) in the form Al salts. A thermal stability of 325° C. was ascertained, and a processing window of 8%.

### EXAMPLE 14

The flame retardant used was a modified FM 2 in which some of the Al cations had been replaced by Fe cations. The total iron content was 20 ppm. A thermal stability of 335° C. was ascertained, and a processing window of 5%.

### EXAMPLE 15

The flame retardant used was a modified FM 2 in which some of the Al cations had been replaced by Fe cations. The total iron content was 1000 ppm. A thermal stability of 375° C. was ascertained, and a processing window of 4.5%.

1. A flame-retardant polyester composition comprising:
thermoplastic polyester as component A;
fillers and/or reinforcers as component B;
phosphinic salt of the formula (I) as component C 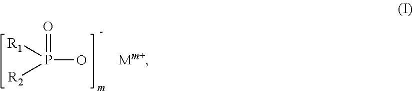
in which R₁ and R₂ are ethyl,
M is Al, Fe, TiOₚ or Zn,
m is 2 to 3, and
p=(4−m)/2;
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D;
phosphonic salt of the formula II as component E 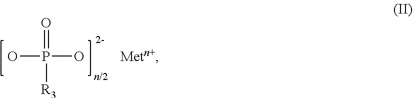
in which R₃ is ethyl,
Met is Al, Fe, TiO_{q} or Zn,
n is 2 to 3, and
q=(4−n)/2;
inorganic phosphonate as component F; and
wax selected from the group consisting of the polyolefin waxes, amide waxes, natural waxes, long-chain aliphatic carboxylic acids and/or esters or salts thereof as component G.

2. The flame-retardant polyester composition as claimed in claim 1, wherein M and Met are Al, m and n are 3, and components D and F are aluminum salts.

3. The flame-retardant polyester composition as claimed in claim 1, wherein
the proportion of component A is 25% to 95% by weight,
the proportion of component B is 1% to 45% by weight,
the proportion of component C is 1% to 35% by weight,
the proportion of component D is 0.01% to 3% by weight,
the proportion of component E is 0.001% to 1% by weight,
the proportion of component F is 0.005% to 6% by weight, and
the proportion of component G is 0.05% to 5% by weight,
where the percentages are based on the total amount of the polyester composition.

4. The flame-retardant polyester composition as claimed in claim 3, wherein
the proportion of component A is 25% to 75% by weight,
the proportion of component B is 20% to 40% by weight,
the proportion of component C is 5% to 20% by weight,
the proportion of component D is 0.05% to 1.5% by weight,
the proportion of component E is 0.01% to 0.6% by weight,
the proportion of component F is 0.05% to 2% by weight, and
the proportion of component G is 0.1% to 2% by weight.

5. The flame-retardant polyester composition as claimed in claim 1, which contain iron in an amount within the range from 0.0001% to 0.2% by weight, preferably from 0.0002% to 0.05% by weight.

6. The flame-retardant polyester composition as claimed in claim 5, wherein at least one of the flame-retardant components C, D, E and F contains iron.

7. The flame-retardant polyester composition as claimed in claim 1, which comprises a melamine polyphosphate having an average degree of condensation of 2 to 200 as component H, preferably a melamine polyphosphate having an average degree of condensation of 20 to 200.

8. The flame-retardant polyester composition as claimed in claim 7, which comprises melamine cyanurate as component I.

9. The flame-retardant polyester composition as claimed in claim 1, which has a comparative tracking index measured according to International Electrotechnical Commission Standard IEC-60112/3 of not less than 500 V.

10. The flame-retardant polyester composition as claimed in claim 1, which attains a UL-94 V-0 assessment at thickness from 3.2 mm to 0.4 mm.

11. The flame-retardant polyester composition as claimed in claim 1, which has a glow wire flammability index according to IEC-60695-2-12 of at least 960° C. at thickness 0.75-3 mm.

12. The flame-retardant polyester composition as claimed in claim 1, which has a glow wire ignition temperature according to IEC-60695-2-13 of at least 750° C. at thickness 0.75-3 mm.

13. The flame-retardant polyester composition as claimed in claim 1, wherein component A comprises one or more polyalkylene terephthalates.

14. The flame-retardant polyester composition as claimed in claim 13, wherein component A is a polyethylene terephthalate.

15. The flame-retardant polyester composition as claimed in claim 13, wherein component A is a polybutylene terephthalate.

16. The flame-retardant polyester composition as claimed in claim 15, wherein the specific viscosity of the polybutylene terephthalate is within the range between 65 and 150 cm³/g, preferably between 100 and 129 cm³/g.

17. The flame-retardant polyester composition as claimed in claim 1, wherein glass fibers are used as component B.

18. The flame-retardant polyester composition as claimed in claim 8, wherein components C, D, E, F, H and I are in particulate form, where the median particle size d₅₀ of these components is 1 to 100 μm.

19. The flame-retardant polyester composition as claimed in claim 1, which comprises an inorganic phosphonate of the formula (III) as component F 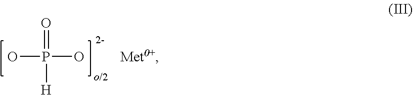
in which Me is Fe, TiOᵣ, Zn or especially Al, o is 2 to 3, and r=(4−o)/2.

20. The flame-retardant polyester composition as claimed in claim 1, wherein component G is an ester or a salt of long-chain aliphatic carboxylic acids having a chain length of C₁₄ to C₄₀.

21. The flame-retardant polyester composition as claimed in claim 1, wherein component G is a polyamide wax which has been prepared by reaction of ammonia or alkylenediamine with saturated and/or unsaturated fatty acids having 14 to 40 carbon atoms.

22. The flame-retardant polyester composition as claimed in claim 8, which comprises further additives as component J, where the further additives are selected from the group consisting of antioxidants, UV stabilizers, gamma ray stabilizers, hydrolysis stabilizers, costabilizers for antioxidants, antistats, emulsifiers, nucleating agents, plasticizers, processing auxiliaries, impact modifiers, dyes, pigments and/or further flame retardants other than components C, D, E, F, H and I.

23. The use of the polyester compositions as claimed in claim 1 for production of fibers, films and moldings, especially for uses in the electricals and electronics sector.

24. The flame-retardant polyester composition as claimed in claim 1, wherein components C, D, E, and F are in particulate form, where the median particle size d₅₀ of these components is 1 to 100 μm.

25. The flame-retardant polyester composition as claimed in claim 1, which comprises further additives as component J, where the further additives are selected from the group consisting of antioxidants, UV stabilizers, gamma ray stabilizers, hydrolysis stabilizers, costabilizers for antioxidants, antistats, emulsifiers, nucleating agents, plasticizers, processing auxiliaries, impact modifiers, dyes, pigments and/or further flame retardants other than components C, D, E, and F.
